(19) United States
(12) Patent Application Publication
(10) Pub. No.: US 2007/0273205 A1
(43) Pub. Date: Nov. 29, 2007

(54) Communication system for use in data communications between power generator and external unit

(75) Inventor: Toru Aoyama, Okazaki-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/802,392

(22) Filed: May 22, 2007

(30) Foreign Application Priority Data
May 22, 2006 (JP) 2006-142178

(51) Int. Cl. H02J 3/02; G05B 11/01; G08B 1/08

(52) U.S. Cl. 307/3; 340/538; 340/310.11

(57) ABSTRACT

In a communication system, a first modulator converts first data created one of a power-generator and an external unit into a first modulated signal, and transmits the first modulated signal to the other of the power-generator and the external unit such that the first modulated signal is superimposed on the output voltage at the output terminal of the power-generator. When a second modulated signal containing second data is transmitted from the other of the power-generator and the external unit such that the second modulated signal is superimposed on the output voltage at the output terminal of the power-generator, a first demodulator receives the transmitted second modulated signal. The first demodulator demodulates the received second modulated signal into the second data.

### CROSS REFERENCE TO RELATED APPLICATION

This application is based on Japanese Patent Application No. 2006-142 filed on May 22, 2006. The descriptions of the patent Application are all incorporated herein by reference.

### BACKGROUND OF THE INVENTION

1. Field of the Invention

The present invention relates to communication systems for use in data communications between a power generator and an external unit and relates to power generators adapted to communicate data with an external unit.

2. Description of the Related Art

A requirement for more advanced vehicle functions has recently grown, and in order to meet the request, various types of electronic components for more advanced vehicle functions have been installed to be networked in a vehicle.

For example, an ECU installed in a vehicle as a master unit and a controller of a chargeable power-generator installed therein as a slave unit are networked to be communicable with each other using, for example, the LIN (Local Interconnect Network) protocol. Some of control methods for communications using the LIN protocol are disclosed in Japanese Unexamined Patent Publication No. 2002-325085.

The control methods based on the LIN protocol allow data communications between an ECU and a controller of a charging generator on a single bus, which makes it possible to achieve complicated data-communications between the ECU and the controller of the charging generator as follows.

Specifically, the ECU is operative to send information indicative of a target voltage to the controller through the single bus based on the LIN protocol. The controller is operative to receive the information sent from the ECU and change, based on the received information, a target voltage to which an output voltage of the charging generator should be regulated.

In addition, the controller is operative to send, to the ECU, information through the single bus based on the LIN protocol; this information is indicative of a duty cycle of a switch element working to energize a field winding of the power-generator. The duty cycle of the switch element working to cause an electric current to be fed to the field winding will be also referred to “power generation ratio”. The ECU is operative to receive the information and correct parameters required for the ECU to control an engine.

Moreover, the controller is operative to send, to the ECU, a diagnosis of the charging generator through the single bus based on the LIN protocol. The ECU is operative to control turning on/off of a charge-warning indicator, which gives warning to the driver.

A communication interface installed in the charging generator and that installed in the ECU, which allow the charging generator and ECU to communicate with each other on a single bus, are for example configured as follows:

Specifically, as illustrated in FIG. 7, a resistor 200, a switch element 210, a voltage comparator 220, and a communication terminal 230 are provided in the charging generator.

The communication terminal 230 is connected to a single bus B. One input terminal of the voltage comparator 220 is connected to the communication terminal 230. A threshold voltage level is configured to be input to the other input terminal of the voltage comparator 220.

A resistor 200 has one end connected to a positive terminal of a battery (not shown), and the other end connected to a point between the one input terminal of the voltage comparator 220 and the communication terminal 230, which allows the communication terminal 230 to be pulled up to a battery terminal voltage Vbatt. One end of the switch element 210 is connected to the point, and the other end thereof grounded. The switch element 210 has a control terminal.

Similarly, a resistor 202, a switch element 212, a voltage comparator 222, and a communication terminal 232 are provided in the ECU.

The communication terminal 232 is connected to the single bus B. One input terminal of the voltage comparator 222 is connected to the communication terminal 232. A threshold voltage level is configured to be input to the other input terminal of the voltage comparator 222.

A resistor 202 has one end connected to a positive terminal of a battery (not shown), and the other end connected to a point between the one input terminal of the voltage comparator 222 and the communication terminal 232, which allows the communication terminal 232 to be pulled up to a battery terminal voltage Vbatt. One end of the switch element 212 is connected to the point, and the other end thereof grounded. The switch element 212 has a control terminal.

When transmitted data with logical low level is input to the control terminal of the switch element 210 of the charging generator, the switch element 210 is turned on. This allows digital data with an electric dominant level (logical low level) to be sent to the input terminal of the voltage comparator 222 of the ECU through the communication terminal 230, the single bus B, and the communication terminal 232. The digital data sent to the voltage comparator 222 is received thereby. The received data is output from the voltage comparator 222 based on a comparison result between the threshold voltage level and the dominant level of the received data.

In contrast, when transmitted data with logical high level is input to the control terminal of the switch element 210 of the charging generator, the switch element 210 is turned off. This allows digital data with an electric recessive level (logical high level) to be sent to the input terminal of the voltage comparator 222 of the ECU through the communication terminal 230, the single bus B, and the communication terminal 232. The digital data sent to the voltage comparator 222 is received thereby. The received data is output from the voltage comparator 222 based on a comparison result between the threshold voltage level and the recessive level of the received data.

Data can be sent from the ECU to the charging generator in the same manner as in the case of sending data from the charging generator to the ECU.

As set forth above, conventional charging generators capable of carrying out data communications with an external ECU require the specific communication terminal 230 in addition to an output terminal thereof at which an electric current is outputted.

The dedicated communication terminal 230 in the charging generator is normally provided in a connector integrated with the case of a regulator built in the charging generator.

In such a conventional charging generator with the communication terminal 230 provided in a connector integrated with a regulator case built therein, is used to be installed in an engine of a vehicle. For this reason, the connector of the conventional charging generator requires adequate structural strength and ensures adequate electrical contact of each terminal therein with a corresponding connection target even if the connector is subjected to vibrations and/or heat created by the engine. This may make it difficult to reduce the connector in size.

In addition, in order to mount the communication terminal 230 on the connector of the regulator case built in the charging generator, it is necessary to:

form an opening in a rear cover of the charging regulator to expose the connector; and

additionally mount the communication terminal 230 through the opening on the exposed connector.

In the configuration of the charging generator, foreign particles, such as pieces of metal, particles of soil, water particles, oil particles, and the like, may enter into the charging generator through the opening. This may cause the environmental resistance of the charging generator to deteriorate.

Then, in order to improve the environmental resistance of the charging generator, it is necessary to provide a specific structure to the rear cover to prevent foreign particles from entering into the charging generator through the opening for the communication terminal 230. In addition, it is necessary to secure waterproof of the fitted portion of the connector.

Accordingly, mounting of the communication terminal through the rear cover of a charging generator using a connector may increase the cost of the charging generator due to the necessity of the specific configurations of the connector with the difficulty in reduction of size.

### SUMMARY OF THE INVENTION

In view of the background, an object of at least one aspect of the present invention is to allow data communications between a power-generator and an external unit without using a dedicated communication terminal.

According to one aspect of the present invention, there is provided a communication system for data communications between a power-generator and an external unit, in which the power-generator is designed to generate an output voltage at an output terminal thereof. The communication system includes a first modulator coupled to the output terminal of the alternator. The first modulator is configured to convert first data into a first modulated signal, the first data being created in one of the power-generator and the external unit, and transmit the first modulated signal to the other of the power-generator and the external unit such that the first modulated signal is superimposed on the output voltage at the output terminal of the alternator. The communication system includes a first demodulator coupled to the output terminal of the alternator. The first demodulator is configured to, when a second modulated signal containing second data is transmitted from the other of the power-generator and the external unit such that the second modulated signal is superimposed on the output voltage at the output terminal of the alternator, receive the transmitted second modulated signal. The first demodulator is configured to demodulate the received second modulated signal into the second data.

According to another aspect of the present invention, there is provided a power-generator having an output terminal and designed to allow data communications with an external unit. The power-generator includes a power generating unit configured to generate an output voltage at the output terminal as output power. The power-generator includes a modulator coupled to the output terminal and configured to convert first data into a first modulated signal, and transmit the first modulated signal to the external unit such that the first modulated signal is superimposed on the output voltage at the output terminal. The power-generator includes a demodulator coupled to the output terminal and configured to, when a second modulated signal containing second data is transmitted from the external unit such that the second modulated signal is superimposed on the output voltage at the output terminal of the alternator, receive the transmitted second modulated signal, and demodulate the received second modulated signal into the second data.

According to a further aspect of the present invention, there is provided a power-generation system. The power-generation system includes a power-generator having an output terminal and including a power generating unit configured to generate an output voltage at the output terminal as output power. The power-generation system includes an external unit having a communication terminal, and a communication bus connecting between the output terminal of the power-generator and the communication terminal of the external unit. The power-generator includes a first modulator coupled to the output terminal of the power-generator and configured to:

convert first data into a first modulated signal, the first data being created in the power-generator; and

transmit the first modulated signal to the external unit via the communication bus such that the first modulated signal is superimposed on the output voltage at the output terminal of the power-generator. The power-generator includes a first demodulator coupled to the output terminal of the power-generator and configured to:

when a second modulated signal containing second data is transmitted from the external unit via the communication bus such that the second modulated signal is superimposed on the output voltage at the output terminal of the power-generator, receive the transmitted second modulated signal; and

demodulate the received second modulated signal into the second data. The external unit includes a second modulator coupled to the output terminal of the power-generator and configured to:

convert the second data created in the external unit into the second modulated signal; and

transmit the second modulated signal to the power-generator via the communication bus such that the second modulated signal is superimposed on the output voltage at the output terminal of the power-generator. The external unit includes a second demodulator coupled to the output terminal of the power-generator and configured to:

when the first modulated signal is transmitted from the power-generator via the communication bus such that the first modulated signal is superimposed on the output voltage at the output terminal of the power-generator, receive the transmitted first modulated signal; and

demodulate the received first modulated signal into the first data.

### BRIEF DESCRIPTION OF THE DRAWINGS

Other objects and aspects of the invention will become apparent from the following description of embodiments with reference to the accompanying drawings in which:

FIG. 1 is a circuit diagram schematically illustrating an example of the structure of a power-generation control system including an alternator and an electronic control unit (ECU) according to an embodiment of the present invention;

FIG. 2 is a circuit diagram schematically illustrating an example of the structure of a power source circuit of the alternator illustrated in FIG. 1;

FIG. 3 is a block diagram schematically illustrating an example of the structure of a modem of the alternator and that of the ECU illustrated in FIG. 1;

FIG. 4 is a timing chart schematically illustrating operating timings of the modems illustrated in FIG. 3;

FIG. 5 is a timing chart schematically illustrating operating timings of modems according to a modification of the embodiment;

FIG. 6 is a circuit diagram schematically illustrating the structure of a modification of the power-generation control system illustrated in FIG. 1; and

FIG. 7 is a circuit diagram of a communication interface installed in a generator and that installed in an ECU, which can communicate with each other using the LIN protocol.

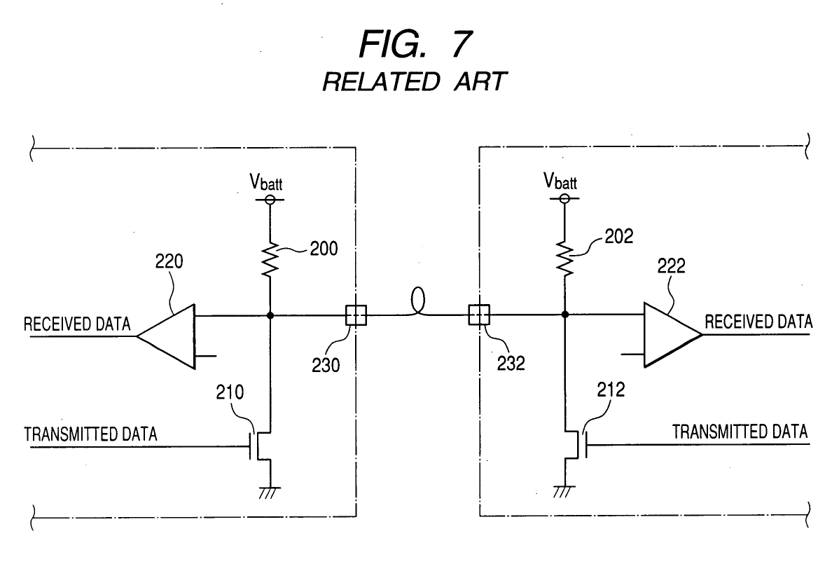

### DETAILED DESCRIPTION OF EMBODIMENTS OF THE INVENTION

An embodiment of the present invention will be described hereinafter with reference to the accompanying drawings.

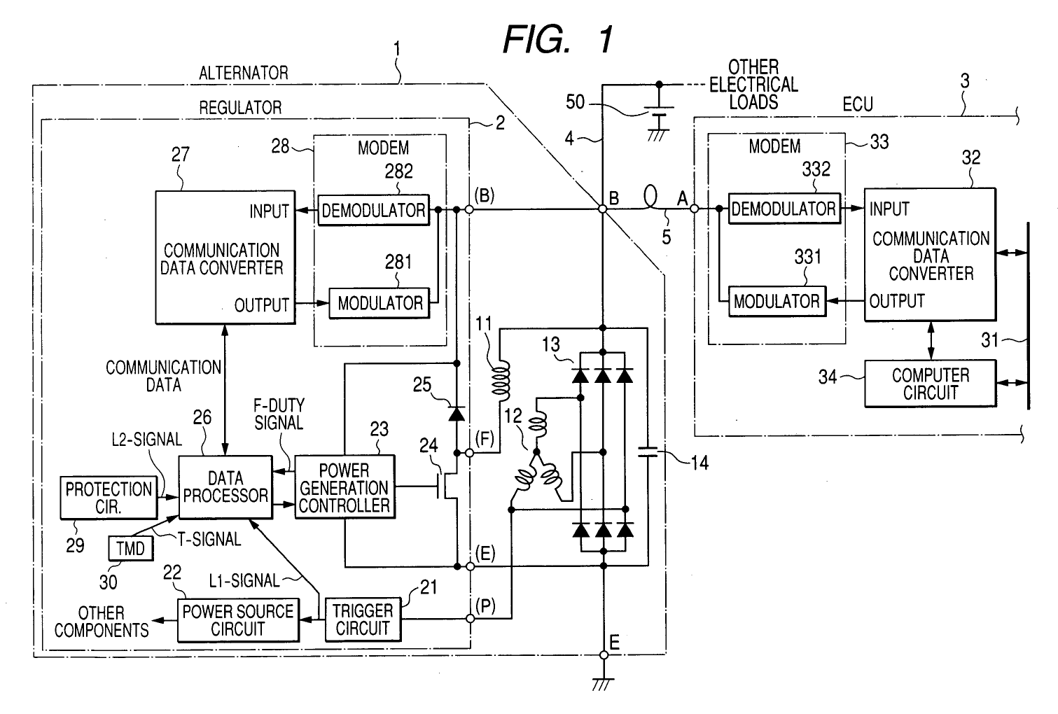

Referring to FIG. 1, there is provided a power-generation control system installed in a vehicle according to an embodiment of the present invention.

The power-generation control system includes an alternator 1 as an example of power-generators, which includes a regulator 2. The power-generation control system also includes an electronic control unit (ECU) 3 as an example of external units.

The alternator 1 has a terminal B to which a B terminal of the regulator 2 is connected. In addition, a positive terminal of a battery 50 and other electrical loads (not shown) are connected to the terminal B of the alternator 1 via a charging line 4. The terminal B of the alternator 1 serves as an output terminal and a communication terminal thereof.

In the embodiment, the positive terminal voltage of the battery 50 is 12V when the battery 50 is fully charged.

The ECU 3 has a terminal A serving as a communication terminal thereof, and the terminal A of the ECU 3 and the terminal B of the alternator 1 are connected with each other via a single communication bus 5.

The alternator 1 also has a ground terminal E serving as, for example, a signal common (signal ground) thereof. A terminal E of the regulator 2 is connected with the ground terminal E of the alternator 1.

The alternator 1 is equipped with a field winding (exciting winding) 11 wound around a core of a rotor to create field poles (north and south poles) alternately arranged when energized. The rotor is coupled to a crankshaft of an engine through a belt to be rotatable therewith.

The alternator 1 is provided with three-phase stator windings 12 connected in, for example, star configuration and wound around a stator core that surrounds the rotor, and a rectifier 13 consisting of, for example, three pairs of positive (high-side) and negative (low-side) diodes connected in the form of a bridge. Specifically, the positive and negative diodes of each pair are connected in series at a connection point, and the connection points of the three-paired diodes are connected with lead wires of the three-phase stator windings 12, respectively.

The cathodes of the high-side diodes are commonly connected with the output terminal B of the alternator 1 via the terminal B of the regulator 2, and the anodes of the low-side diodes are commonly connected with the ground terminal E of the alternator 1. One end of the exciting winding 11 is connected with the cathodes of the high-side diodes, and the other end thereof is connected with an F terminal of the regulator 2.

The alternator 1 is also provided with a capacitor 14 connected between the output terminal B and the ground terminal E thereof in parallel to the rectifier 13.

In the alternator 1, when the field winding 11 is energized while the rotor rotates, the rotating field winding 11 creates magnetic fluxes. The created magnetic fluxes magnetize the core to provide the field poles.

The rotation of the filed poles creates magnetic fluxes, and the created magnetic fluxes induce a three-phase AC voltage in the three-phase stator windings 12. The rectifier 13 full-wave rectifies the induced three-phase AC voltage induced in the stator windings 12 to a direct current (DC) voltage. The full-wave rectified DC voltage is output through the output terminal B so that the output DC voltage is supplied to the battery 50 and the electrical loads.

The capacitor 14 is operative to reduce electrical noise contained in the output DC voltage.

The output voltage of the alternator 1 depends on the number of rotation of the rotor and the amount of the field current to be supplied to the field winding 11.

Thus, the regulator 2 is operative to control the field current to be supplied to the field winding 11.

Specifically, the regulator 2 includes a trigger circuit 21, a power source circuit 22, a power-generation controller 23, a switch element 24, flywheel diode 25, a data processor 26, a communication data converter 27, a modulator-demodulator (modem) 28, a protection circuit 29, and a temperature measuring device (abbreviated as “TMD”) 30.

The trigger circuit 21 is connected with a P terminal of the regulator 2 and to the data processor 26. One phase winding of the three-phase stator windings 12 is connected with the P terminal. This allows one phase voltage of the three-phase stator windings 12 to be input to the trigger circuit 21.

For example, the trigger circuit 21 consists of a comparator, and is operative to compare the one phase voltage with a predetermined threshold voltage, and to output, to the power source circuit 22 and the data processor 26, a trigger signal with a low level when the one phase voltage is greater than the threshold voltage. The trigger signal to be supplied to the data processor 26 will be referred to as “L-1 signal” hereinafter.

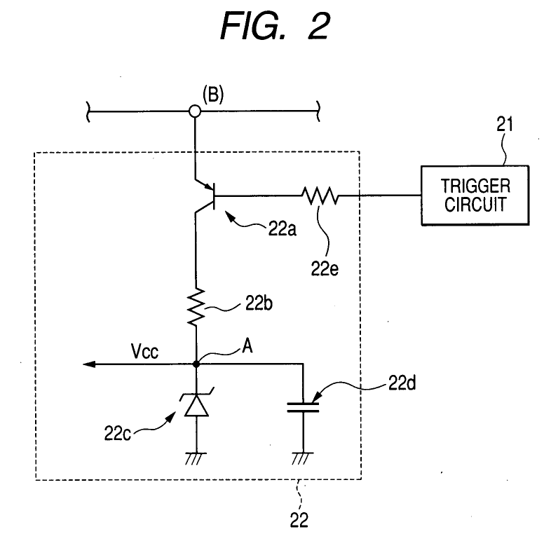

As illustrated in FIG. 2, the power source circuit 22 includes a switch element 22a, such as a PNP transistor, a resistor 22b, a constant voltage circuit 22c, a capacitor 22d, and a resistor 22e. The resistor 22b and the capacitor 22d serve as a smoothing circuit. The constant voltage circuit 22c consists of a zener diode.

Specifically, the base of the switch element 22a is connected with an output terminal of the trigger circuit 21 via the resistor 22e, and the emitter thereof is connected with the output terminal B of the alternator 1 through the B terminal of the regulator 2. The collector of the switch element 22a is connected with one end of the resistor 22b.

The other end of the resistor 22b is connected at a tap A to the cathode of the zener diode 22c in series, and the anode thereof is grounded. The capacitor 22d is connected at one electrode to the other end of the resistor 22b at the tap A in parallel to the zener diode 22c. The other electrode of the capacitor 22c is grounded.

The zener diode 22c has a predetermined breakdown voltage (zener voltage Vz).

In the structure of the power source circuit 22, when no trigger signals with the low level are supplied from the trigger circuit 21 to the base of the switch element 22a, the switch element 22a is in off state so that no operating voltage is created by the power source circuit 22.

In contrast, when the trigger signal with the low level is supplied from the trigger circuit 21 to the base of the switch element 22a, the switch element 22a is turned on. The on-state of the switch element 22a allows the voltage at the output terminal B of the alternator 1 to be applied across the zener diode 22c through the resistor 22b. It is to be noted that the voltage at the output terminal B of the alternator 1, which is equivalent to a potential at the positive terminal of the battery 50 when no output power is generated by the alternator 1.

The voltage at the output terminal B of the alternator 1 applied across the zener diode 22c through the resistor 22b permits the voltage at the tap A to be set to a substantially constant voltage based on the zener voltage Vz and the voltage drop across the switch element 22a. The smoothing circuit of the resistor 22b and the capacitor 22d is operative to remove ripples from the voltage at the output terminal B.

The power source circuit 22 is configured to supply the substantially constant voltage as an operating voltage Vcc to the other components of the regulator 2.

The power-generation controller 23 is connected with the data processor 26 and to the terminals B and E of the alternator 1 via the respective B and E terminals of the regulator 2. The power-generation controller 23 is operative to create a control signal for controlling on and off operations of the switch element 24 based on the voltage at the output terminal B of the alternator 1 and a preset target voltage. The power-generation controller 23 is also operative to send, to the data processor 26, a duty (duty cycle) of the switch element 24 as an F-duty signal under the on and off control.

The target voltage can be preset to, for example, 14 V, which is suitable for charging the battery 3 in normal state whose charging voltage is 12 V.

Specifically, in the embodiment, the duty cycle of the switch element 24 working to control duration of an electric current being fed to the field winding 11 equivalently means “power generation ratio” of the alternator 1.

The duty cycle of the switch element 24 means the ratio of the on duration of the switch element 24 to each switching (on and off) period. For example, when the switch element 24 is continuously on state, the duty cycle of the switch element 24 is set to 100%, which allows the switch element 24 to supply a maximum field current to the field winding 11.

In contrast, when the switch element 24 is continuously off state, the duty cycle of the switch element 24 is set to 0%, which causes the switch element 24 to interrupt the electric current to the field winding 11.

To sum up, the duty cycle of the switch element 24 shows the ratio of the field current to the maximum field current, that is, the conductivity of the switch element 24, which is equivalent to the power generation rate of the alternator 1.

The switch element 24 consists of a power transistor, such as an n-channel MOSFET.

Specifically, the gate of the switch element 24 is connected with an output terminal of the power-generation controller 23, and the drain thereof is connected with the output terminal B of the alternator 1 through the flywheel diode 25. The source of the switch element 24 is connected with the E terminal of the regulator 2 (the ground terminal E of the alternator 1) to be grounded. The drain of the switch element 24 is also connected with the other end of the field winding 11 via the F terminal of the regulator 2.

The flywheel diode 25 is connected at its cathode to the output terminal B of the alternator 1 via the B terminal of the regulator 2 and at its anode to the drain of the switch element 24 to be parallel to the field winding 11.

Specifically, when the switch element 24 is turned on, a field current flows through the filed winding 11 based on the voltage at the output terminal B of the alternator 1. In contrast, when the switch element 24 is turned off, the field current continues to flow through the flywheel diode 25.

The protection circuit 29 is operative to determine whether the output voltage of the alternator 1 drops up to a preset level, and output a charge-warning indicator control signal to the data processor 26 as an L-2 signal.

The temperature measuring device 30 is operative to periodically measure a temperature inside the alternator 1, and periodically supply, to the data processor 26, a T-signal indicative of the measured temperature.

The data processor 26 is operative to receive signals indicative of the operating conditions of the alternator 1. The operating condition signals include the F-duty signal supplied from the power-generation controller 23, L-1 signal supplied from the trigger circuit 21, L-2 signal supplied from the protection circuit 29, and T-signal supplied from the temperature measuring device 30. The operating condition signals of the alternator 1 are required for the ECU 3 to carry out predetermined tasks, and therefore, they are passed to the communication data converter 27 as first communication data.

For example, the predetermined tasks to be carried out by the ECU 3 include a task to control turning on/off of a charge-warning indicator mounted on an instrument panel of the vehicle below an windshield thereof based on the alternator operating condition signals.

The data processor 26 is also operative to receive second communication data passed from the communication data converter 27. The second communication data includes data to change the target voltage depending on the driving condition of the vehicle; this data to change the target voltage has been transmitted from the ECU 3.

Specifically, the power-generation controller 23 is operative to change (adjust) the target voltage to a value to be sent from the ECU 3 via the components 28, 27, and 26 depending on, for example, the acceleration or deceleration of the vehicle.

Preferably, the second communication data externally sent from the ECU 3 allows the power-generation controller 23 to:

reduce the target voltage to thereby reduce the output power of the alternator 1 while the vehicle is being accelerated; and

increase the target voltage to store regenerative electric power in the battery 50 when the vehicle is being decelerated.

The communication data converter 27 is also operative to receive a message passed from the modulator and demodulator 28, convert the received message into second communication data to be transmitted to the data processor 26, and output it thereto.

The modulator and demodulator 28 is composed of a modulator 281 and a demodulator 282.

The modulator 281 has an input terminal and an output terminal. The input terminal of the modulator 281 is connected with an output terminal “OUTPUT” of the communication data converter 27, and the output terminal of the modulator 281 is connected with the output terminal B of the alternator 1.

The demodulator 282 has an input terminal and an output terminal. The input terminal of the demodulator 282 is connected with the output terminal B of the alternator 1, and the output terminal of the demodulator 282 is connected with an input terminal “INPUT” of the communication data converter 27.

The modulator 281 is operative to receive a message input from the communication data converter 27 and convert the received message into a first information signal to be superimposed on the voltage at the output terminal B of the alternator 1, thereby creating a modulated signal.

The demodulator 282 is operative to receive a modulated signal transmitted from the ECU 3 and demodulate a message from the received modulated signal.

Next, an example of the structure of the ECU 3 will be described hereinafter.

In the embodiment, the output terminal B of the alternator 1 is connected with the terminal A of the ECU 3 via the communication bus 5.

Under the connection relationship between the ECU 3 and the alternator 1, the ECU 3 and the alternator 1 are networked to be communicable with each other via the communication bus 5 using the LIN protocol. Under the LIN protocol, the ECU 3 serves as a master unit and the alternator 1 serves as a slave unit.

Specifically, the ECU 3 and the regulator 2 of the alternator 1 can communicate with each other using, for example, the control methods for communications using the LIN protocol, which are disclosed in Japanese Unexamined Patent Publication No. 2002-325085. The regulator 2 of the alternator 1 serving as a slave unit of the ECU 3 is configured to be controlled by the ECU 3.

As illustrated in FIG. 1, the ECU 3 includes a data bus 31, a communication data converter 32, a modulator and demodulator (modem) 33, and a computer circuit 34. The communication data converter 32 and the computer circuit 34 are connected with each other via the data bus 31 such that they communicate data with each other via the data bus 31. The communication data converter 32 and the computer circuit 34 are also connected with each other such that they communicate commands with each other.

In the embodiment, for example, the modem (modulator 281 and demodulator 282) 28 and the modem (modulator 331 and demodulator 332) 33 correspond to a communication system for use in data communications between the alternator 1 and the ECU 3.

The communication data converter 32 is operative to receive data on the data bus 31 in response to a command passed from the computer circuit 34, convert the received data into a message to be transmitted to the modem 33, and output it thereto. For example, as a message, a command to change the target voltage can be used.

The communication data converter 32 is also operative to receive a message passed from the modem 33, convert the received message into data to be asserted on the data bus 31, and output it thereon.

The modulator and demodulator 33 is composed of a modulator 331 and a demodulator 332.

The modulator 331 has an input terminal and an output terminal. The input terminal of the modulator 331 is connected with an output terminal “OUTPUT” of the communication data converter 32, and the output terminal of the modulator 331 is connected with the output terminal B of the alternator 1.

The demodulator 332 has an input terminal and an output terminal. The input terminal of the demodulator 332 is connected with the output terminal B of the alternator 1, and the output terminal of the demodulator 332 is connected with an input terminal “INPUT” of the communication data converter 32.

The modulator 331 is operative to receive a message input from the communication data converter 32 and convert the received message into a second information signal to be superimposed on the voltage at the output terminal B of the alternator 1 via the communication bus 5, thereby creating a modulated signal.

The demodulator 332 is operative to receive a modulated signal transmitted from the alternator 1 and demodulate a message from the received modulated signal.

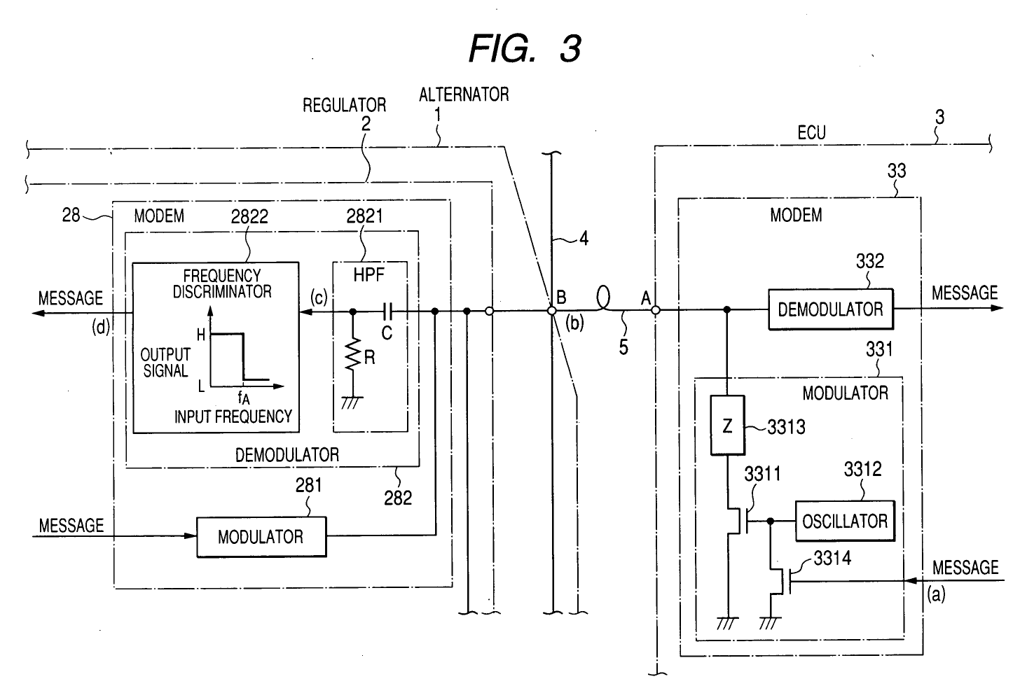

FIG. 3 schematically illustrates an example of the structure of each of the modems 28 and 33.

Referring to FIG. 3, the structure of the modulator 281 is substantially identical to that of the modulator 331, and therefore, the structure of the modulator 281 is omitted in FIG. 3. Similarly, the structure of the demodulator 332 is substantially identical to that of the demodulator 282, and therefore, the structure of the demodulator 332 is omitted in FIG. 3.

As illustrated in FIG. 3, the modulator 331 includes a first transistor 3311, a second transistor 3314, an oscillator 3312, and an impedance circuit 3313. In the embodiment, as the first and second transistors 3311 and 3314, N-channel MOSFETs are used.

The drain of the first transistor 3311 is connected with the terminal A of the ECU 3 via the impedance circuit 3313 with a predetermined magnitude impedance Z. The source of the first transistor 3311 is grounded.

The gate of the first transistor 3311 is connected to the oscillator 3312. The drain of the second transistor 3314 is connected with a tap between the gate of the first transistor 3311 and the oscillator 3312. The gate of the second transistor 3314 is connected to the output terminal of the communication data converter 32.

The oscillator 3312 is operative to generate a periodic signal, such as a square wave signal or a sinusoidal wave signal, and output the generated periodic signal to the gate of the first transistor 3311.

When the second transistor 3314 is in off state, the periodic signal input to the gate of the first transistor 3311 is amplified to be output from the drain of the first transistor 3311.

For example, as the impedance circuit 3313, a parallel resistance-capacitance circuit consisting of a resistor and a capacitor parallely connected with each other, or a parallel inductance-capacitance circuit consisting of a coil and a capacitor parallely connected with each other.

The impedance circuit 3313 is operative to cause the periodic signal to oscillate at a predetermined high frequency that is determined depending on the combined impedance thereof.

In contrast, when the second transistor 3314 is in on state, the first transistor 3311 is in off state, so that no periodic signal input to the gate of the first transistor 3311 is amplified to be output from the drain of the first transistor 3311.

On the other hand, the demodulator 282 includes a high-pass filter (HPF) 2821 and a frequency discriminator 2822.

For example, as the high-pass filter 2821, a CR (capacitance-resistance) filter consisting of a capacitor C and a resistor R is used. One electrode of the capacitor C is connected with the output terminal B of the alternator 1, and the other electrode of the capacitor C is connected with one end of the resistor R at a tap. The other end of the resistor R is grounded. The tap between the other electrode of the capacitor C and the one end of the resistor R is connected with an input terminal of the frequency discriminator 2822.

The high-pass filter 2821 is operative to permit periodic signals superimposed on the voltage at the output terminal B each with a frequency higher than a predetermined cut-off frequency to pass therethrough.

The frequency discriminator 2822 is operative to compare the frequency of an input periodic signal passing through the high-pass filter 2821 with a predetermined threshold frequency f_{A}.

When it is discriminated that the frequency of the input periodic signal is lower than the threshold frequency f_{A}, the frequency discriminator 2822 is operative to output a signal with a high level, such as 5 V, which corresponds to a bit of logical “1”.

Otherwise when it is determined that the frequency of the input periodic signal is higher than the threshold frequency f_{A}, the frequency discriminator 2822 is operative to output a signal with a low level, such as 0 V, which corresponds to a bit of logical “0”.

Operations of the power-generation control system will be described hereinafter.

First, basic operations of the power-generation control system will be described hereinafter.

When the engine rotates with rotation of the rotor, because magnetizing force remains in the core of the rotor to provide the field poles thereof, the rotation of the filed poles of the rotor creates magnetic fluxes. The created magnetic fluxes induce a three-phase microvoltage in the three-phase stator windings 12 without flow of a filed current through the field winding 11.

One-phase voltage in the three-phase microvoltage is input to the trigger circuit 21.

In the embodiment, the magnitude of the one phase voltage is set to be greater than that of the threshold voltage of the trigger circuit 21.

For this reason, the trigger circuit 21 determines that the one phase voltage is greater than the threshold voltage level, so that the trigger circuit 21 outputs the trigger signal with the low level to the power source circuit 22.

As described above, in response to the trigger signal, the power source circuit 22 supplies, as the operating voltage Vcc, the substantially constant voltage based on the zener voltage Vz and the voltage drop across the switch element 22a to the other components of the regulator 2. This allows the regulator 2 to shift into a mode in which it can generate power.

On the other hand, the voltage (potential) at the output terminal B is supplied to the power generation controller 23.

The power generation controller 23 compares a monitor voltage depending on the voltage at the output terminal B with the preset target voltage. When the preset target voltage is greater than the monitor voltage, the power generation controller 23 outputs a switching signal with a high level, and the high-level switching signal turns the switch element 24 on.

This allows a field current to flow through the field winding 11 of the rotor based on the voltage at the output terminal B of the alternator 1. The filed current flowing through the field winding 11 of the rotor that is rotating creates magnetic fluxes so that the magnetizing force in the core is increased. This allows the magnitude of the three-phase voltage induced in the thee-phase stator windings 12 to increase.

The increase in the three-phase voltage induced in the three-phase stator windings 12 allows the output voltage of the alternator 1 at the output terminal B to increase, so that the monitor voltage depending on the voltage at the output terminal B of the alternator 1 increases.

As a result, when the monitor voltage approximately reaches the preset target voltage, the output of the power generation controller 23 is turned from the high level to a low level. This causes the switch element 24 to become off, so that the field current decreases.

The decrease in the field current reduces the voltage at the output terminal B of the alternator 1, so that the monitor voltage depending on the voltage at the output terminal B of the alternator 1 decreases. This causes the output of the power generation controller 23 to be returned to the high level, allowing the switch element 24 to be turned on. The on state of the switch element 24 increases the filed current flowing through the filed winding 11.

The increase in the field current increases the voltage at the output terminal B of the alternator 1, so that the monitor voltage depending on the voltage at the output terminal B of the alternator 1 increases.

These field-current control operations based on the on/off control of the switch element 24 allow the output terminal B of the alternator 1 to be regulated to the preset target voltage. The regulated voltage at the output terminal B of the alternator 1 is supplied to the battery 50 and the other electrical loads.

Next, operations of the alternator control system for communicating data with the ECU 3 using the modems 28 and 33 will be described hereinafter.

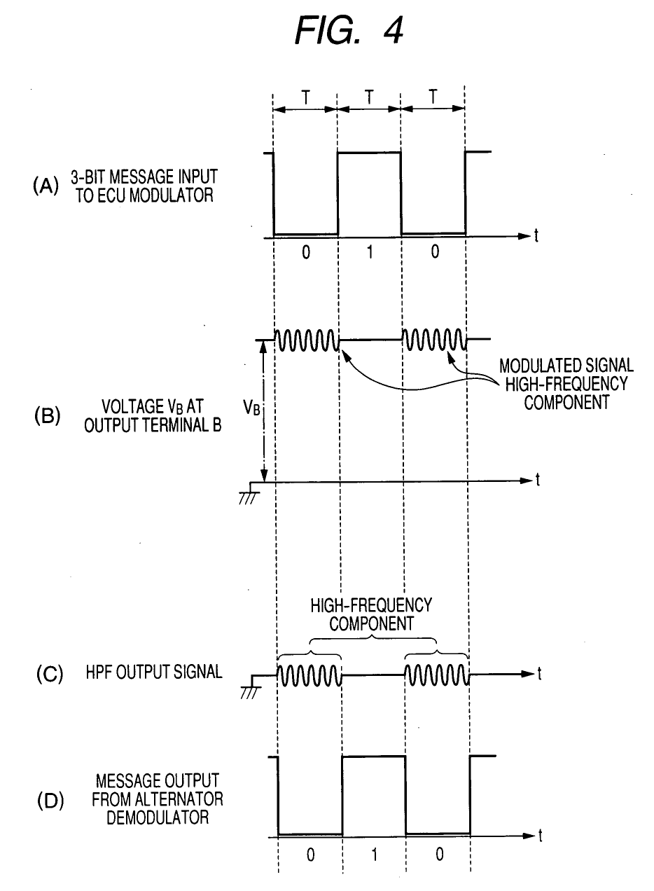

FIG. 4 schematically illustrates a timing chart that shows operating timings of the modems 28 and 33.

In the embodiment, operations of the modems 28 of the alternator 1 and the modem 33 of the ECU 3 for transmitting a 3-bit message “010” from the ECU 3 to the alternator 1 will be described hereinafter as an example. Note that a bit of logical “0” of the 3-bit message has a predetermined low voltage, such as 0 V, in digital data (binary data), and a bit of logical “1” of the 3-bit message has a predetermined high voltage, such as 5 V, in digital data (binary data).

Specifically, the 3-bit message sent from the computer circuit 34 via the communication data converter 32 is input to the gate of the second transistor 3314.

When the first bit of “0” is input to the gate of the second transistor 3314 (see (A) in FIG. 4), the low voltage corresponding to the first bit of “0” causes the second transistor 3314 to be turned off. This allows the periodic signal generated by the oscillator 3312 to be input to the gate of the first transistor 3311.

Thus, the periodic signal is amplified, so the amplified periodic signal is input to the impedance circuit 3313.

The amplified periodic signal input to the impedance circuit 3313 is oscillated at the predetermined high frequency thereby, whereby an oscillating signal is generated to be output from the impedance circuit 3313.

For example, the oscillating signal has the predetermined high frequency f, a predetermined peak-to-peak amplitude Vₚ₋ₚ of 200 mV.

The oscillating signal is transmitted from the modem 33 via the terminal A and the communication bus 5 to be superimposed on the voltage V_{B} at the output terminal B of the alternator 1 as a high-frequency component (see (B) in FIG. 4).

Preferably, adjustment of the combined impedance of the impedance circuit 3313 allows the predetermined high frequency f of the oscillating signal to be set to a frequency higher than a bit frequency in hertz of the data transfer of the 3-bit message from the communication data converter 32.

For example, assuming that a duration T of a bit of the 3-bit message is set to 50 μs (see (A) in FIG. 4), the bit frequency in hertz of the data transfer of the 3-bit message is set to 0.01 MHz. In contrast, the predetermined high frequency f of the oscillating signal is set to 5 MHz corresponding to a period of 0.2 μs thereof.

On the other hand, the second bit of “1” is input to the gate of the second transistor 3314 (see (A) in FIG. 4), the high voltage corresponding to the second bit of “1” causes the second transistor 3314 to be turned on. This permits the first transistor 3311 to be turned off, which prevents the periodic signal generated by the oscillator 3312 from being output from the first transistor 3311 toward the impedance circuit 3313.

Thus, no oscillating signal (high-frequency component) is superimposed on the voltage V_{B} of the output terminal B of the alternator 1 (see (B) in FIG. 4).

As described above, the 3-bit message of “010” created by the ECU 3 is converted into a modulated signal consisting of:

a non-periodic component whose signal level is the voltage V_{B} of the alternator output terminal B, which is synchronized with the input timing of the second bit of “1” of the 3-bit message of “010” to the modulator 331; and

the high-frequency components superimposed on the voltage V_{B} at the alternator output terminal B, which are respectively synchronized with the input timings of the first and third bits of “0” of the 3-bit message of “010” to the modulator 331. The modulated signal converted by the modulator 331 is sent to the regulator 2 of the alternator 1 via the communication bus 5.

The frequency f of high-frequency components of a modulated signal to be transmitted between the ECU 3 and the alternator 1 is set to be higher than frequencies of switching noises superimposed on the voltage at the output terminal B of the alternator 1 when the switch element 24 is turned on and off in an exciting circuit. The exciting circuit is composed of the field winding 11, the flywheel diode 25 parallely connected thereto, and the switch element 24.

The frequency f of high-frequency components of a modulated signal to be transmitted between the ECU 3 and the alternator 1 is set to be higher than frequencies of commutation noises in synchronization with the number of revolutions of the rotor (alternator 1); these commutation noises are caused during the rectifying operations of the rectifier 13.

The reason why the frequency f of high-frequency components of a modulated signal to be transmitted between the ECU 3 and the alternator 1 is limited set forth above is as follows:

Specifically, the capacitor 14 connected between the output terminal B of the alternator 1 and the ground terminal E thereof allows electrically oscillating noises consisting of the switching noises and the commutation noises to be attenuated with time. For example, the oscillating noises have an attenuation characteristic with time while oscillating within a frequency range between several tens kHz and several hundred kHz.

Thus, if the frequency f of high-frequency components of a modulated signal to be transmitted between the ECU 3 and the alternator 1 is set to be lower than the frequencies of the oscillating noises, the modems 28 and 33 may mistake the oscillating noises as high-frequency components of a modulated signal.

That is, setting of the frequency f of high-frequency components of a modulated signal to be higher than the frequencies of the oscillating noises can prevent the modems 28 and 33 from mistaking the oscillating noises as high-frequency components of a modulated signal.

When the modulated signal corresponding to the message “010” is sent to the regulator 2 of the alternator 1 via the communication bus 5 and the output terminal B, the modulated signal is received by the high-pass filter 2821 of the demodulator 282.

In the embodiment, the cut-off frequency of the high-pass filter 2821 is set to be close to and lower than the frequency f of the high-frequency components of the modulated signal.

For this reason, the high-pass filter 2821 allows the high-frequency components superimposed on the voltage V_{B} at the output terminal B of the alternator 1 to accurately pass therethrough (see (C) in FIG. 4).

Specifically, a modulated signal is superimposed on the voltage V_{B} at the output terminal B of the alternator 1. For this reason, even if a DC (Direct Current) component of the voltage V_{B} at the output terminal B of the alternator 1 varies within an allowable range from, for example, 8 V to, for example, 18 V, the modulated signal follows the variation in the voltage V_{B} at the output terminal B of the alternator 1.

Thus, connection of the high-pass filter 2821 with the output terminal B of the alternator 1 allows the high-frequency components of the modulated signal to be reliably captured by the high-pass filter 2821.

A signal with the high-frequency components of the first modulated signal passed through the high-pass filter 2821 is input to the frequency discriminator 2822 (see (C) in FIG. 4).

In the frequency discriminator 2822, a frequency of the signal input to the frequency discriminator 2822 is compared with the threshold frequency f_{A} of, for example, 1 MHz. It is to be noted that the threshold frequency f_{A} is set be higher than the frequencies of the oscillating noises.

Because the frequency f (5 MHz) of the high-frequency components is higher than the threshold frequency f_{A} (1 MHz), when a high-frequency component is input to the frequency discriminator 2822, a bit of logical “0” corresponding to a signal with the low level is outputted from the frequency discriminator 2822 as the comparison result.

In contrast, when a signal component whose frequency is lower than the threshold frequency f_{A} (1 MHz) is input to the frequency discriminator 2822, a bit of logical “1” corresponding to a signal with the high level is outputted from the frequency discriminator 2822 as the comparison result.

That is, when the 3-bit message “010” is converted into the modulated signal by the modulator 331 to be transmitted from the ECU 3 to the alternator 1, the modulated signal corresponding to the 3-bit message “010” is demodulated into a 3-bit message of “010” by the demodulator 282 to be outputted therefrom (see (D) in FIG. 4).

Similarly, when the regulator 2 wants to transmit a 3-bit message “010” to the ECU 3, the 3-bit message “010” is converted into the modulated signal by the modulator 281 to be transmitted from the alternator 1 to the ECU 3. The modulated signal corresponding to the 3-bit message “010” is demodulated into a 3-bit message of “010” by the demodulator 332 to be outputted therefrom.

As set forth above, in the power-generation control system, communication data composed of bits of “0” and/or “1” are converted into a modulated signal consisting of at least one non-periodic component corresponding to one of the bits “0” and “1” and at least one periodic component corresponding to the other of the bits “0” and “1”.

Thus, even if such a modulated signal is transmitted, via the output terminal B of the alternator 1, from, for example, the modem 28 of the alternator 1 to the modem 33 of the ECU 3, the data configuration of the modulated signal allows the modem 33 of the ECU 3 to reliably demodulate the communication data modulated on the modulated signal.

Accordingly, in the power-generation control system, it is unnecessary to mount, onto the alternator case, a communication terminal and a connector, which were conventionally required for data communications with the ECU 3. Especially, this can eliminate a dedicated communication terminal and a connector, which were conventionally required for data communications with the ECU 3, making it possible to reduce the regulator 2 in size and suppress the increase in the cost of the alternator 1.

In addition, an exposed connector of a conventional alternator may be drawn out in an axial direction of the rotational axis of the rotor or in a radial direction thereof depending on the routing of wires of the vehicle. The differences of the connectors of conventional alternators in arrangement may increase the number of types of regulators and/or alternators having the same functions; these types of regulators and/or alternators are designed depending on the different connector positions.

However, in the embodiment, no connectors can be used to provide the communication terminal in the alternator 1 for communicating data with the ECU 3 because the output terminal B of the alternator 1 has served as the communication terminal. This allows the productivity of the alternators 1 according to the embodiment to increase without the increase of the types thereof, making it possible to reduce the alternators 1 in cost.

The demodulators 282 and 332 have the high-pass filter 2821 that allows the high-frequency components, whose frequency is higher than the cut-off frequency, superimposed on the voltage at the alternator output terminal B to only pass therethrough.

For this reason, it is possible for the frequency discriminator 2822 to detect the high-frequency components independently of the magnitude of DC component in the output voltage of the alternator 1.

Specifically, if the alternator output voltage is changed from its transient state to its steady state when the regulated voltage is changed, or if it is transiently changed when an electrical load connected with the alternator output terminal B is power on or interrupted, a modulated signal with the high-frequency components is superimposed on the alternator output voltage while following the change thereof.

Even if the alternator output voltage is changed as described above, because the cut-off frequency of the high-pass filter 2821 is set to be close to and lower than the frequency f of the high-frequency components, it is possible to accurately receive the high-frequency components independently of the change in the alternator output voltage.

In the embodiment, for example, the modem (modulator 281 and demodulator 282) 28 and the modem (modulator 331 and demodulator 332) 33 correspond to a communication system for use in data communications between the alternator 1 and the ECU 3. The present invention however is not limited to the structure. Specifically, another type of communication units that allows communications of such a modulated signal with one of the alternator 1 and the ECU 3 can be used in place of the modem of the other of the alternator 1 and the ECU 3. In this modification, the modem of one of the alternator 1 and the ECU 3 can correspond to a communication system for use in data communications between the alternator 1 and the ECU 3.

In the embodiment, a modulated signal created by the modulator 331 (281) consists of:

at least one non-periodic component whose signal level is the voltage V_{B} of the alternator output terminal B, which is synchronized with the input timing of at least one bit of “1” of a message to the modulator 331 (281); and

at least one high-frequency component superimposed on the voltage V_{B} at the alternator output terminal B, which is synchronized with the input timing of at least one bit of “0” of the message to the modulator 331.

However, the present invention is not limited to the structure.

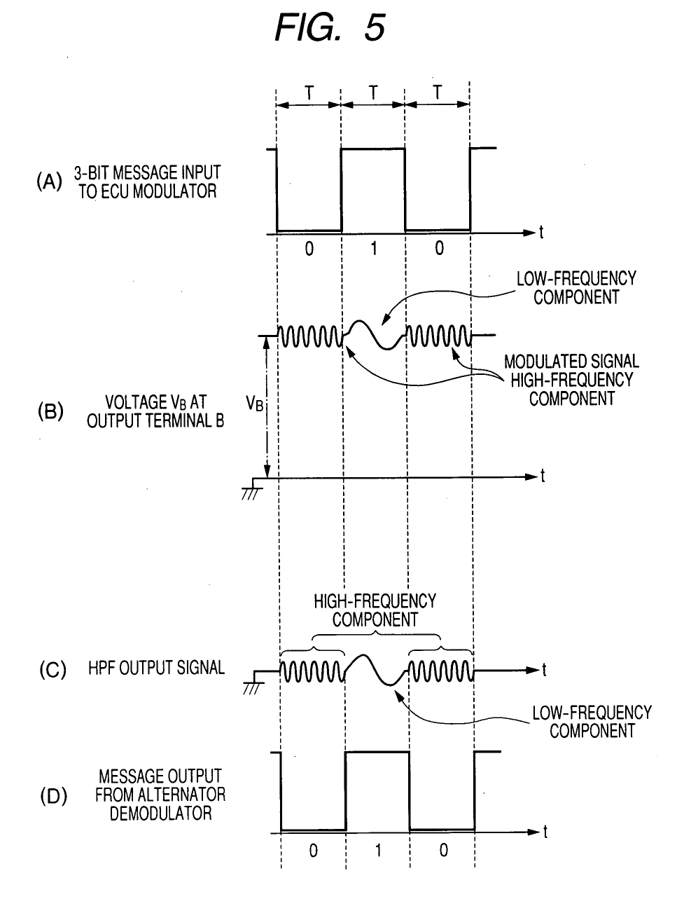

Specifically, as illustrated in FIG. 5, a 3-bit message of “010” created by the ECU 3 can be converted into another type of modulated signal consisting of:

a low-frequency component having a frequency f1 superimposed on the voltage V_{B} at the alternator output terminal B, which is synchronized with the input timing of the second bit of “1” of the 3-bit message of “010” to the modulator 331; and

high-frequency components having the frequency f and superimposed on the voltage V_{B} at the alternator output terminal B, which are respectively synchronized with the input timings of the first and third bits of “0” of the 3-bit message of “010” to the modulator 331. The frequency f1 of the low-frequency component is lower than the frequency f of the high-frequency component. The frequency f1 of the low-frequency component is set to be lower than the threshold frequency f_{A} of the frequency discriminator 2822. Preferably, the frequency f1 of the low-frequency component can be set to be lower than the cut-off frequency of the high-pass filter 2821.

As well as the embodiment, even if another type of a modulated signal set forth above is transmitted, via the output terminal B of the alternator 1, from, for example, the modem 28 of the alternator 1 to the modem 33 of the ECU 3, the data configuration of the modulated signal allows the modem 33 of the ECU 3 to reliably demodulate the communication data modulated on another type of the modulated signal.

Moreover, in the embodiment, the frequency f of the high-frequency components is set to be higher than the predetermined threshold frequency f_{A} set to be higher than the frequency range of the oscillating noises caused by the alternator 1. This can prevent the frequency discriminator 2822 from mistaking the oscillating noises as the high-frequency components contained in a modulated signal.

In the embodiment and its modifications, the modem 28 is installed in the regulator 2 of the alternator 1, but the modem 28 can be provided independently of the alternator 1 and communicably coupled to the regulator 2 of the alternator 1 and to the output terminal B of the alternator 1. Similarly, the modem 33 is installed in the ECU 3, but the modem 33 can be provided independently of the ECU 3 and communicably coupled to the ECU 3 and to the output terminal B of the alternator 1.

In the embodiment and its modifications, the alternator 1 is installed in a vehicle, but the present invention is not limited to the structure. Specifically, the alternator 1 can be configured to be installable in various types of machines.

In the embodiment, as described above, the second communication data externally input to the regulator 2 of the alternator 1 allows the power-generation controller 23 to adjust the target voltage depending on, for example, the acceleration or deceleration of the vehicle.

When no second communication data has been externally input to the regulator 2, the regulator 2 of the alternator 1 can be configured to carry out fail-safe power generation.

For example, the data processor 26 has stored therein a default value corresponding to, for example, 14 V suitable for charging the battery 3 in normal state whose charging voltage is 12 V.

When no second communication data has been externally input to the regulator 2, the data processor 26 passes the default value to the power generation controller 23. The power generation controller 23 works to create a control signal for controlling on and off operations of the switch element 24 based on the voltage at the output terminal B of the alternator 1 and the default value to thereby adjust the output voltage of the alternator 1 to be matched to 14 V.

In the embodiment, as the high-pass filter 2821 in each of the demodulators 282 and 332, an analog filter consisting of, for example, a capacitor C and a resistor R is used, but the present invention is not limited to the structure.

Specifically, a digital filter with a comparatively high sensitive frequency characteristic can be used as the high-pass filter in place of the analog filter.

In place of the high-pass filter 2821 in each of the demodulators 282 and 332, a band-pass filter (BPF) can be used. The band-pass filter is operative to permit a modulated signal superimposed on the voltage at the output terminal B each with a frequency higher than a predetermined cut-off frequency to pass therethrough. This allows unwanted signal components whose frequencies lower than the predetermined cut-off frequency to be eliminated by the band-pass filter at the input stage of the demodulator 282.

In the embodiment, the alternator 1 and the ECU 3 are configured to communicate with each other via the communication bus 5, but the present invention is not limited to the structure.

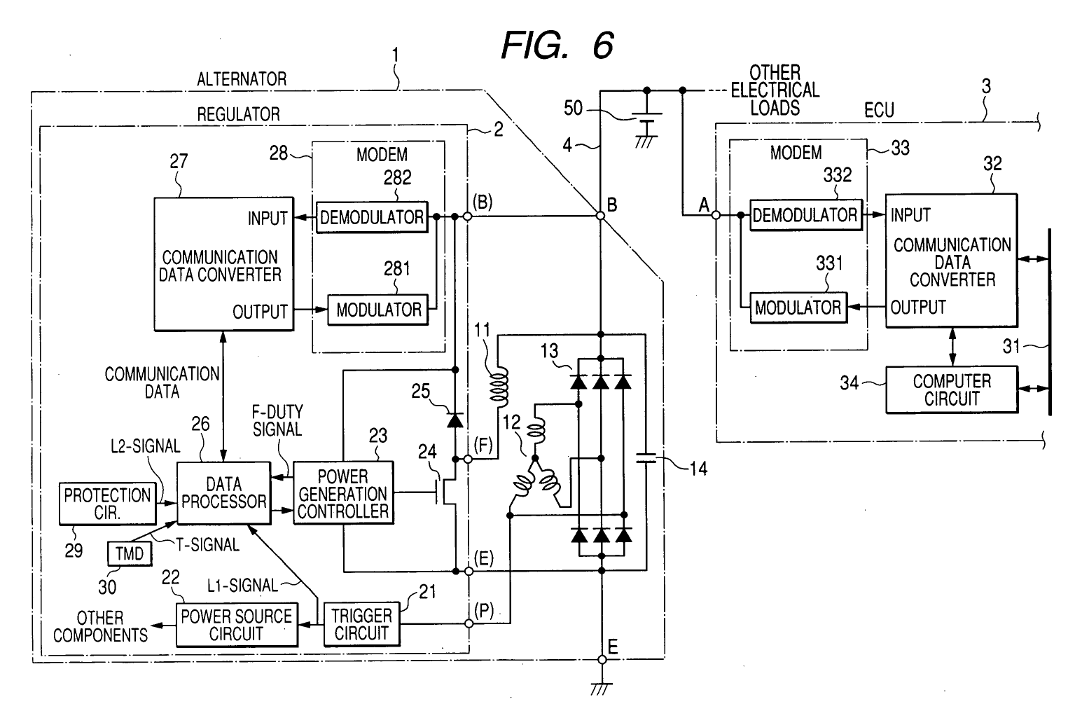

Specifically, the alternator 1 and the ECU 3 can be configured to communicate with each other via the alternator output terminal B. For example, FIG. 6 schematically illustrates the structure of a modification of the power-generation control system illustrated in FIG. 1.

Referring to FIG. 6, the communication terminal A of the ECU 3 can be communicably connected to the output terminal B of the alternator 1 via the charging line 4.

Preferably, as illustrated in FIGS. 1 and 3, the charging line 4 and the communication bus 5 are separately provided, and the communication terminal A of the ECU 3 is communicably coupled to the output terminal B of the alternator 1 via the communication bus 5. The structure allows the terminal B of the alternator 1 to serve as both the output terminal and the external communication terminal of the alternator 1.

As compared with communications between the alternator 1 and the ECU 3 via the charging line 4 (see FIG. 6), communications between the alternator 1 and the ECU 3 via the communication bus 5 can prevent a modulated signal superimposed on the voltage at the output terminal B from being attenuated due to impedance components of the battery 50, the other electrical loads, and the charging line itself.

This can reduce the peak-to-peak level of a modulated signal (see (B) in FIG. 4) to be transferred from the modulator 281 or 331 via the communication bus 5, making it possible to eliminate the effect of noise due to a modulated signal on the other electrical loads and to downsize the modulators 281 and 331.

A modulated signal to be transmitted from the ECU 3 to the alternator 1 and that to be transmitted from the alternator 1 to the ECU 3 can be identical to each other or identifiable from each other. For example, a modulated signal to be transmitted from the ECU 3 to the alternator 1 and that to be transmitted from the alternator 1 to the ECU 3 are different from each other in signal characteristic, such as amplitude, frequency, phase, and/or the like.

While there has been described what is at present considered to be the embodiment and modifications of the present invention, it will be understood that various modifications which are not described yet may be made therein, and it is intended to cover in the appended claims all such modifications as fall within the true spirit and scope of the invention.

What is claimed is:

1. A communication system for data communications between a power-generator and an external unit, in which the power-generator is designed to generate an output voltage at an output terminal thereof, the communication system comprising:
a first modulator coupled to the output terminal of the power-generator and configured to:
convert first data into a first modulated signal, the first data being created in one of the power-generator and the external unit; and
transmit the first modulated signal to the other of the power-generator and the external unit such that the first modulated signal is superimposed on the output voltage at the output terminal of the power-generator; and
a first demodulator coupled to the output terminal of the power-generator and configured to:
when a second modulated signal containing second data is transmitted from the other of the power-generator and the external unit such that the second modulated signal is superimposed on the output voltage at the output terminal of the power-generator, receive the transmitted second modulated signal; and
demodulate the received second modulated signal into the second data.

2. A communication system according to claim 1, further comprising:
a second modulator coupled to the output terminal of the power-generator and configured to:
convert the second data created in the other of the power-generator and the external unit into the second modulated signal; and
transmit the second modulated signal to one of the power-generator and the external unit such that the second modulated signal is superimposed on the output voltage at the output terminal of the power-generator; and
a second demodulator coupled to the output terminal of the power-generator and configured to:
when the first modulated signal is transmitted from one of the power-generator and the external unit such that the first modulated signal is superimposed on the output voltage at the output terminal of the power-generator, receive the transmitted first modulated signal; and
demodulate the received first modulated signal into the first data.

3. A communication system according to claim 1, wherein the first data is composed of at least one bit of logical 0 or logical 1, the first modulator is configured to receive the first data being transferred thereto from a component of one of the power-generator and the external unit, and the first modulated signal converted by the first modulator includes:
a first signal component having a first frequency and corresponding to one of the logical 0 and logical 1; and
a second signal component having a second frequency and corresponding to the other of the logical 0 and logical 1, the first frequency of the first signal component and the second frequency of the second signal component being different from each other, the first and second frequencies being higher than a bit frequency of the transfer of the first data in one of the power-generator and the external unit.

4. A communication system according to claim 3, wherein, when the first frequency of the first signal component is lower than the second frequency of the second signal component, the first frequency is set to zero so that the first signal component is equivalent to the output voltage at the output terminal of the power-generator.

5. A communication system according to claim 3, wherein, when the first frequency of the first signal component is lower than the second frequency of the second signal component, the first demodulator includes a filtering unit having a predetermined passing frequency band, the second frequency of the second signal component being set to lie within the predetermined frequency band, the first frequency of the first signal component being set to be out of the predetermined frequency band.

6. A communication system according to claim 5, wherein the first demodulator further includes a discriminating unit configured to discriminate the second frequency of the second signal component based on a predetermined threshold frequency, and the predetermined threshold frequency of the discriminating unit is set to be higher than a frequency of an electrically oscillating noise, the electrically oscillating noise being caused by output-voltage generating operations of the power-generator.

7. A communication system according to claim 6, wherein the second frequency of the second signal component is set to be higher than the predetermined threshold frequency.

8. A communication system according to claim 1, wherein the second data is composed of at least one bit of logical 0 or logical 1, the second modulator is configured to receive the second data being transferred thereto from a component of the other of the power-generator and the external unit, and the second modulated signal converted by the second modulator includes:
a first signal component having a first frequency and corresponding to one of the logical 0 and logical 1; and
a second signal component having a second frequency and corresponding to the other of the logical 0 and logical 1, the first frequency of the first signal component and the second frequency of the second signal component being different from each other, the first and second frequencies being higher than a bit frequency of the transfer of the second data in the other of the power-generator and the external unit.

9. A communication system according to claim 8, wherein, when the first frequency of the first signal component is lower than the second frequency of the second signal component, the first frequency is set to zero so that the first signal component is equivalent to the output voltage at the output terminal of the power-generator.

10. A communication system according to claim 8, wherein, when the first frequency of the first signal component is lower than the second frequency of the second signal component, the second demodulator includes a filtering unit having a predetermined passing frequency band, the second frequency of the second signal component being set to lie within the predetermined frequency band, the first frequency of the first signal component being set to be out of the predetermined frequency band.

11. A communication system according to claim 10, wherein the second demodulator further includes a discriminating unit configured to discriminate the second frequency of the second signal component based on a predetermined threshold frequency, and the predetermined threshold frequency of the discriminating unit is set to be higher than a frequency of an electrically oscillating noise, the electrically oscillating noise being caused by output-voltage generating operations of the power-generator.

12. A communication system according to claim 11, wherein the second frequency of the second signal component is set to be higher than the predetermined threshold frequency.

13. A power-generator having an output terminal and designed to allow data communications with an external unit, the power-generator comprising:
a power generating unit configured to generate an output voltage at the output terminal as output power;
a modulator coupled to the output terminal and configured to:
convert first data into a first modulated signal; and
transmit the first modulated signal to the external unit such that the first modulated signal is superimposed on the output voltage at the output terminal; and
a demodulator coupled to the output terminal and configured to:
when a second modulated signal containing second data is transmitted from the external unit such that the second modulated signal is superimposed on the output voltage at the output terminal of the power-generator, receive the transmitted second modulated signal; and
demodulate the received second modulated signal into the second data.

14. A power-generator according to claim 13, wherein the first data is composed of at least one bit of logical 0 or logical 1, the modulator is configured to receive the first data being transferred thereto from a component of the power-generator, and the first modulated signal converted by the modulator includes:
a first signal component having a first frequency and corresponding to one of the logical 0 and logical 1; and
a second signal component having a second frequency and corresponding to the other of the logical 0 and logical 1, the first frequency of the first signal component and the second frequency of the second signal component being different from each other, the first and second frequencies being higher than a bit frequency of the transfer of the first data in the power-generator.

15. A power-generator according to claim 14, wherein, when the first frequency of the first signal component is lower than the second frequency of the second signal component, the first frequency is set to zero so that the first signal component is equivalent to the output voltage at the output terminal of the power-generator.

16. A power-generator according to claim 14, wherein, when the first frequency of the first signal component is lower than the second frequency of the second signal component, the demodulator includes a filtering unit having a predetermined passing frequency band, the second frequency of the second signal component being set to lie within the predetermined frequency band, the first frequency of the first signal component being set to be out of the predetermined frequency band.

17. A power-generator according to claim 16, wherein the demodulator further includes a discriminating unit configured to discriminate the second frequency of the second signal component based on a predetermined threshold frequency, and the predetermined threshold frequency of the discriminating unit is set to be higher than a frequency of an electrically oscillating noise, the electrically oscillating noise being caused by output-voltage generating operations of the power-generator.

18. A power-generator according to claim 17, wherein the second frequency of the second signal component is set to be higher than the predetermined threshold frequency.

19. A power-generation system comprising:
a power-generator having an output terminal and including a power generating unit configured to generate an output voltage at the output terminal as output power;
an external unit having a communication terminal; and
a communication bus connecting between the output terminal of the power-generator and the communication terminal of the external unit,
the power-generator including:
a first modulator coupled to the output terminal of the power-generator and configured to:
convert first data into a first modulated signal, the first data being created in the power-generator; and
transmit the first modulated signal to the external unit via the communication bus such that the first modulated signal is superimposed on the output voltage at the output terminal of the power-generator; and
a first demodulator coupled to the output terminal of the power-generator and configured to:
when a second modulated signal containing second data is transmitted from the external unit via the communication bus such that the second modulated signal is superimposed on the output voltage at the output terminal of the power-generator, receive the transmitted second modulated signal; and
demodulate the received second modulated signal into the second data,
the external unit including:
a second modulator coupled to the output terminal of the power-generator and configured to:
convert the second data created in the external unit into the second modulated signal; and
transmit the second modulated signal to the power-generator via the communication bus such that the second modulated signal is superimposed on the output voltage at the output terminal of the power-generator; and
a second demodulator coupled to the output terminal of the power-generator and configured to:
when the first modulated signal is transmitted from the power-generator via the communication bus such that the first modulated signal is superimposed on the output voltage at the output terminal of the power-generator, receive the transmitted first modulated signal; and
demodulate the received first modulated signal into the first data.

20. A power-generation system according to claim 19, wherein the first data is composed of at least one bit of logical 0 or logical 1, the first modulator is configured to receive the first data being transferred thereto from a component of the power-generator, and the first modulated signal converted by the first modulator includes:
a first signal component having a first frequency and corresponding to one of the logical 0 and logical 1; and
a second signal component having a second frequency and corresponding to the other of the logical 0 and logical 1, the first frequency of the first signal component and the second frequency of the second signal component being different from each other, the first and second frequencies being higher than a bit frequency of the transfer of the first data in the power-generator.

21. A power-generation system according to claim 20, wherein, when the first frequency of the first signal component is lower than the second frequency of the second signal component, the first frequency is set to zero so that the first signal component is equivalent to the output voltage at the output terminal of the power-generator.

22. A power-generation system according to claim 20, wherein, when the first frequency of the first signal component is lower than the second frequency of the second signal component, the first demodulator includes a filtering unit having a predetermined passing frequency band, the second frequency of the second signal component being set to lie within the predetermined frequency band, the first frequency of the first signal component being set to be out of the predetermined frequency band.

23. A power-generation system according to claim 22, wherein the first demodulator further includes a discriminating unit configured to discriminate the second frequency of the second signal component based on a predetermined threshold frequency, and the predetermined threshold frequency of the discriminating unit is set to be higher than a frequency of an electrically oscillating noise, the electrically oscillating noise being caused by output-voltage generating operations of the power-generator.

24. A power-generation system according to claim 23, wherein the second frequency of the second signal component is set to be higher than the predetermined threshold frequency.

25. A power-generation system according to claim 20, wherein the second data is composed of at least one bit of logical 0 or logical 1, the second modulator is configured to receive the second data being transferred thereto from a component of the external unit, and the second modulated signal converted by the second modulator includes:
a third signal component having a third frequency and corresponding to one of the logical 0 and logical 1; and
a fourth signal component having a fourth frequency and corresponding to the other of the logical 0 and logical 1, the third frequency of the third signal component and the fourth frequency of the fourth signal component being different from each other, the third and fourth frequencies being higher than a bit frequency of the transfer of the second data in the external unit.

26. A power-generation system according to claim 25, wherein, when the third frequency of the third signal component is lower than the fourth frequency of the fourth signal component, the third frequency is set to zero so that the third signal component is equivalent to the output voltage at the output terminal of the power-generator.

27. A power-generation system according to claim 25, wherein, when the third frequency of the third signal component is lower than the fourth frequency of the fourth signal component, the second demodulator includes a filtering unit having a predetermined passing frequency band, the fourth frequency of the fourth signal component being set to lie within the predetermined frequency band, the third frequency of the third signal component being set to be out of the predetermined frequency band.

28. A power-generation system according to claim 27, wherein the second demodulator further includes a discriminating unit configured to discriminate the fourth frequency of the fourth signal component based on a predetermined threshold frequency, and the predetermined threshold frequency of the discriminating unit is set to be higher than a frequency of an electrically oscillating noise, the electrically oscillating noise being caused by output-voltage generating operations of the power-generator.

29. A power-generation system according to claim 28, wherein the fourth frequency of the fourth signal component is set to be higher than the predetermined threshold frequency.

30. A power-generation system according to claim 29, wherein the second frequency of the second signal component of the first modulated signal is set to be different from the fourth frequency of the fourth signal component of the second modulated signal.
